(19) United States
(12) Patent Application Publication
(10) Pub. No.: US 2026/0176960 A1
(43) Pub. Date: Jun. 25, 2026

(54) Installation Time Design of Micropiles

(71) Applicant: Deep Reach Technology, Inc., Houston, TX (US)

(72) Inventors: Steven Rizea, Kissimmee, FL (US); James Adamson, West Palm Beach, FL (US); Jon Machin, Saffron Walden (GB); Sanjana Das, Orlando, FL (US); Kamlesh Joshi, Oviedo, FL (US)

(73) Assignee: Deep Reach Technology, Inc., Houston, TX (US)

(21) Appl. No.: 19/126,484

(22) PCT Filed: Nov. 3, 2023
(86) PCT No.: PCT/US2023/078723

§ 371 Date: May 1, 2025

Related U.S. Application Data
(60) Provisional application No. 63/382,288, filed on Nov. 3, 2022.

(51) Int. Cl. E21B 47/01; E21B 49/00; G01V 11/00

(52) U.S. Cl. CPC E21B 47/01; E21B 49/005; G01V 11/002; G01V 2200/16

(57) ABSTRACT

A method and apparatus for drilling micropiles, measuring parameters at the micropile drill site, and using the data to determine the anchoring capacity of the micropile installation site.

### RELATED APPLICATIONS

This application is a national phase of PCT/US23/78723, which claims priority to U.S. Provisional Application No. 63/382,288 filed Nov. 3, 2022.

This invention was made with government support under contract DE-SC0020896 awarded by DOE, the Department of Energy. The government has certain rights in the invention.

### BACKGROUND

Micropiles are small diameter piles (<250 mm in diameter) that are drilled and grouted into the ground. Once installed, a micropile can withstand some amount of vertical and/or horizontal load without moving. One use of this ability to withstand load is to anchor a structure to the ground. Subsea micropiles build on terrestrial micropile technology to allow installation into the seabed. Once installed on the seabed, a subsea micropile can provide anchoring like a micropile on land. In some instances, multiple subsea micropiles can be connected via a steel drilling template to allow for greater anchoring capacity than a single micropile can provide.

The amount of anchoring that a micropile, or group of micropiles, can provide depends on the ground conditions where it is installed. Standard micropile design practice requires geotechnical and geophysical surveys to determine the ground conditions. These surveys are costly and require specialized vessels and equipment that is not readily available. There is a need for a lower-cost solution to collecting the data required for micropile anchor design calculations.

### SUMMARY OF EXAMPLE EMBODIMENTS

An example embodiment may include a method for collecting geotechnical data during the installation of a micropile comprising supporting one or more geotechnical and/or geophysical sensors using a micropile installation drill as a platform, attaching a drill bit to the micropile installation drill, installing the one or more geotechnical and/or geophysical sensors such that they do not interfere with normal operations of the micropile installation drill, collecting data on drilling parameters from the micropile installation drill, alternating between drilling and data collection procedures, collecting geophysical and/or geotechnical data with a micropile in the drilled hole, collecting geophysical and/or geotechnical data with drill rod in the drilled hole, collecting geophysical and/or geotechnical data with a drill bit in the drilled hole, wherein the drill bit has a hole in it passing the one or more geotechnical and/or geophysical sensors through it, and wherein the drilling equipment does not need to be removed from the drilled hole in order to collect geotechnical and/or geophysical data.

An example embodiment may include a method for collecting geotechnical data during the installation of a micropile comprising supporting one or more geotechnical and/or geophysical sensors using a micropile installation drill as a platform, collecting data on drilling parameters from the micropile installation drill, alternating between drilling and data collection procedures, wherein the drilling equipment does not need to be removed from the drilled hole in order to collect geotechnical and/or geophysical data.

A variation of the example embodiment may include attaching a drill bit to the micropile installation drill. It may include the drill bit having a hole in it passing the one or more geotechnical and/or geophysical sensors through it. It may include installing the one or more geotechnical and/or geophysical sensors such that they do not interfere with normal operations of the micropile installation drill. It may include collecting geophysical and/or geotechnical data with a micropile in the drilled hole. It may include collecting geophysical and/or geotechnical data with drill rod in the drilled hole. It may include collecting geophysical and/or geotechnical data with a drill bit in the drilled hole.

An example embodiment may include a method for calculating the anchoring capacity of a micropile during the installation of the micropile comprising consolidating data from one or more geotechnical geophysical sensors that collect data during the micropile installation process, using the consolidated data from the sensors to determine the geotechnical parameters of the substrate into which the micropile is installed, using the geotechnical parameters to calculate the anchoring capacity of the micropile.

A variation of the example embodiment may include using geophysical and/or geotechnical data available before micropile installation begins. It may include using data on drilling parameters collected from the micropile installation drill. It may include calculating the anchoring capacity of a plurality of micropiles working in concert. It may include calculating the micropile anchoring capacity before the micropile installation drill is removed from the installation site. It may include calculating the micropile anchoring capacity after the micropile installation drill is removed from the installation site. It may include using software to automatically calculate the anchoring capacity of a micropile. It may include using software to automatically calculate the anchoring capacity of a plurality of micropiles working in concert.

An example embodiment may include a method for collecting geotechnical data during the installation of a micropile template comprising using a drill having a drill bit to create a hole in the ground or seabed, and using the drill to deploy sensors to collect geophysical and/or geotechnical data.

A variation of the example embodiment may include collecting geophysical and/or geotechnical data with at least one drill rod and/or micropile in the drilled hole. It may include collecting geophysical and/or geotechnical data with the drill bit already in the drilled hole. It may include attaching the drill onto the micropile template after the template is placed on the ground or seabed at the intended micropile installation location. It may include comprising attaching the drill onto the micropile template before the template is placed on the ground or seabed at the intended micropile installation location. It may include using the collected data to calculate the anchoring capacity of a micropile installed through the template. It may include using the collected data to calculate the anchoring capacity of a plurality of micropiles working in concert and installed through the template.

An example embodiment may include a latching system to connect geotechnical and/or geophysical sensors to a micropile or drill rod comprising a wireline winch system capable of lifting and lowering equipment down the center of the drill rod and/or micropile, a latch that connects to a geotechnical and/or geophysical sensor on one end and the wireline winch system on the other, a latch adapter that connects to the micropile or drill rod and engages with the latch, latch blocks that form part of the latch and extend or retract to allow the latch to lock to, or release from, the latch adapter, latch links that connect to the latching blocks and the latch wireline termination and cause the latching blocks to retract when tension is applied to the latch wireline termination, a spring that causes the latching blocks to extend when there is no tension on the latch wireline termination.

An example embodiment may include a system for latching geotechnical and/or geophysical sensors to a micropile drilling system comprising a latch adapter having an upper end attached to a drill rod or micropile, a lower end attached to a drill bit, and a central longitudinal latch adapter cavity entirely therethrough having an internal wall and a latching feature on the internal wall, a latch body at least partially within the latch adapter cavity having a central longitudinal latch body cavity extending into the latch body from an upper end and at least one latch channel extending from the latch body cavity to an outer surface of the latch body, a cap having an open end attached to the upper end of the latch body and a closed upper end distal from the latch body and having a through hole in the closed upper end, wherein the cap creates a cap cavity between its upper end and the upper end of the latch body, an actuator rod at least partially within the cap cavity and at least partially within the latch body cavity and having an upper end extending through the through hole in the upper end of the cap attached to a cable, a lower end within the latch body cavity, a shoulder portion having an outer diameter large enough to prevent its entry into the latch adapter cavity, and a wire cavity longitudinally from its lower end to its upper end, a spring biasing the actuator rod away from the cap and toward the latch body, at least one latching block within the at least one latch channel connected to the actuator rod by at least one latch link, wherein the spring bias causes the at least one link to exert an outward radial force on the latching block engaging the latching block with the latching feature on the internal wall of the drill adapter, and wherein a force on the cable overcoming the spring bias causes the at least one link to exert an inward radial force on the latching block disengaging the latching block from the latching feature on the internal wall of the drill adapter.

A variation of the example embodiment may include tapered lead ins at the upper end of the drill adapter adapted to compress the one or more latching blocks inward against the spring bias as the latch body is inserted into the drill adapter cavity. It may include the latching blocks transfer downward force from the drill rod or micropile to the latch body and at least one sensor attached to the lower end of the latch body. It may include the latching feature is a groove in the inner wall. It may include the drill adapter is integral with the drill bit.

### BRIEF DESCRIPTION OF THE DRAWINGS

For a thorough understanding of the disclosed embodiments, reference is made to the following detailed description of the example embodiments, taken in conjunction with the accompanying drawings in which reference numbers designate like or similar elements throughout the several figures of the drawing. Briefly:

FIG. 1 is an example a vessel at the ocean surface connected to a micropile system.

FIG. 2 is an example embodiment of a micropile with attached sensor.

FIG. 3 is an example embodiment of a drill and sensor.

FIG. 4 is a front view of a nodule collector with multiple collector head embodiments of the collector.

FIG. 5 is a three-dimensional rendering of a nodule collector with the above embodiments integrated with a sub-structure and tracks for mobility on the seafloor.

FIG. 6 is an example schematic of an example embodiment.

### DETAILED DESCRIPTION OF EXAMPLE EMBODIMENTS

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems, and method steps. It is to be expected that various equivalents, alternatives, and modifications are possible within the scope of the appended claims.

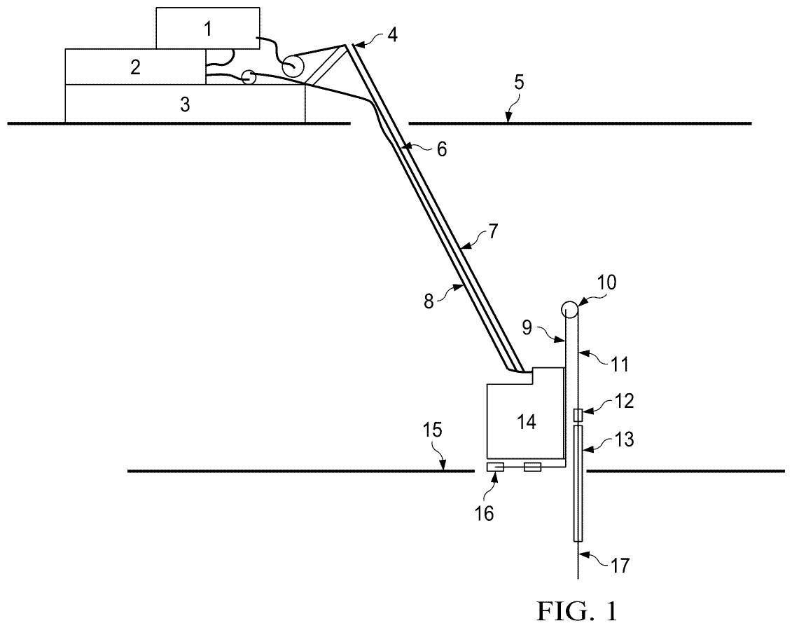

FIG. 1 discloses an embodiment of the apparatus and sensors for collecting necessary geotechnical and geophysical data while drilling. The Installation Time Design, herein “ITD” system is shown as an example embodiment in FIG. 1. In one example it utilizes a cone penetration test, herein “CPT” to perform data collection, however several other types of sensors can be used to collect data, including: seismic cone penetration test (SCPT), pressure meter test (PMT), Goodman Jack device, cavity dilation pressure measurement, needle penetration test, scratch test, direct in-situ compressive strength measurement, x-ray diffraction, nuclear densitometer, nuclear magnetic resonance (NMR), geophysical seismic imaging, Acoustic Zoom, and turning vane test.

Software for interpretation of the data to develop design criteria for the pile spread. It includes a drilling system management 1 and an ITD data management collection 2, located on board a vessel 3. An overboarding system 4, drill umbilical 6, drilling mud supply 7, and ITD umbilical 8 transition from the sea surface 5 to a micropile drill 14 located on the ground or at the seabed 15. If the application is on land rather than at sea, the vessel 3, overboarding system 4, and sea surface 5 will not be present; and the drill umbilical 6, drilling mud supply 7, and ITD umbilical 8 may or may not be present. Seismic sensors 16 are located on the ground or on the seabed 15 in this example embodiment and coupled to the ITD data management collection 2 via seismic data cable 9. The wireline winch 10 raises and lowers the wireline umbilical 11, carrying the geophysical or geotechnical sensor 17, through a wireline mud valve 12.

Referring to FIG. 1, the Installation Time Design, herein “ITD” system, is used in during the operation of a micropile installation rig. Data collection software and control of the TID hardware are positioned in a shelter near the micropile installation drill controls. The data collection component of the system consists of sensors which are deployed and recovered through the center of the drill rod string or micropile 13 by means of a wireline system. A ball valve (the mud valve) isolates the sensor system from the drill string during drilling by blocking the passage through the drill motor.

In an example embodiment, the system operates by alternating between sensor deployment and drilling. The process for operating the subsea ITD equipment is as follows. When a testing depth is reached, drilling stops, and the drill is withdrawn at least the length of a single drill or micropile rod. The mud valve is opened, and the wireline winch is paid out. This lowers the sensor through the center of the drive motor and down through the drill string. Features on the sensor system latch into position after the sensor tip extends through the hole in the center of the drill bit. In one example embodiment, the instrumented system collects geotechnical data from the inner surface of the drilled hole. In another example embodiment, the instrumented system is pushed into the undrilled soil by the drill rig for the length of a single drill or micropile rod. Geotechnical or geophysical data is collected. The wireline winch withdraws the wireline, which automatically unlatches the sensor system from the drill string and lifts it out of the drill string. The sensor system is withdrawn to a stowed position above the drill motor by the wireline winch, the mud valve is closed, and drilling recommences.

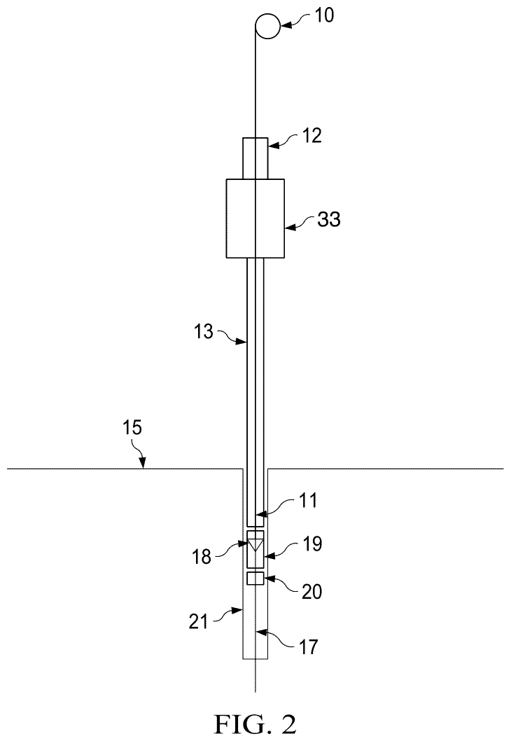

FIG. 2 schematically depicts an example embodiment of the rig's operation adapted for wireline CPT data collection. The wireline winch 10 is coupled to a wireline umbilical 11, which can be lowered through a wireline mud valve 12, the drill head 33, and the drill rod or micropile 13. The ground or seabed is penetrated by the drill bit 20 to form drilled hole 21. Latching assembly 18 is coupled to the latch adaptor 19 that is coupled to the drill bit 20. In this example embodiment the first step is to drill to testing depth using standard drilling procedures, then raise the drill at least the length of one drill rod, stop the drilling mud flow, and then open the wireline mud valve 12, lower sensor 17 and latching assembly 18 on the wireline through drill rod or micropile to passively latch into features in the latch adapter 19. Sensor 17, in this example a CPT probe, now extends approximately the length of one drill or micropile rod beyond the drill bit. The example embodiment prepares to collect CPT data, it then initiates a drill rig vertical push at 2 cm/sec. Push for the length of one drill or micropile rod. It then stops the drill rig push. Wireline winch 10 retains controlled back tension throughout the push. Once data has been collected, it hoists on the wireline to release latch 18, hoist sensor 17 and latching assembly clear of drill bit 20 and secure, close wireline valve, then resume normal drilling activity.

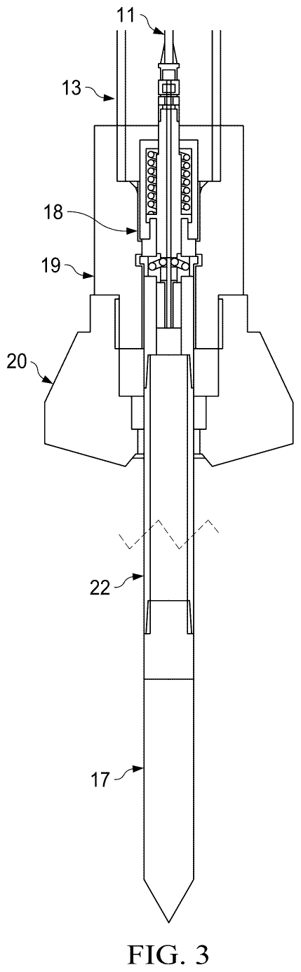

FIG. 3 depicts an example embodiment of system components of a latch system used on a micropile. The wireline umbilical 11 is coupled to the latch 18. The latch 18 is enclosed within the latch adaptor 19. Drill bit 20 is coupled to the latch adaptor 19. Rod 22 protrudes from the drill bit 20 and includes a sensor 17, in this case a CPT, on the end.

A Digital data logger which provides power to the sensor, receives the sensor data stream, and receives depth information from the rig is off-the-shelf equipment and will be used for this system.

For purposes of this example embodiment, communications between the wireline winch and the data collection equipment pass through spare conductors in the drill rig's umbilical and slip ring, although an alternate configuration could be independent umbilical to the data collection system.

In an example embodiment the assembly is structurally attached above the drive motor so that the wire is centered directly over the wireline valve, which is centered over the cylindrical passage through the drive motor of the drill rig. This allows the latch to be lowered through the drive motor and down the drill string when the winch is paid out. An alternative configuration could have the drill head move out of the way, avoiding the need to pass the sensor system and latch pass through the drive motor.

An example embodiment may include a low-speed high torque radial piston hydraulic drive motor. An electric motor and gearbox could also be used, depending on the drill rig's capabilities.

In an example embodiment operation, the winch will be paid out at low tension, set by the weight of the latching adapter and sensor assembly. Once the latching adapter assembly is engaged, the winch wire goes to zero tension. The winch then stops and is put into “constant tension” mode. This mode keeps a small tension on the wire as the wire is paid out while drill rig pushes the latching adapter and CPT assembly downward.

The wireline winch 10 has several other functions: it provides the puling force to release the latching blocks during normal operations, which allows the latching adapter and sensor assembly to be retracted after a sensor push. It also is required to provide additional pull, should the down-wire assembly get jammed or otherwise stuck. In a total failure scenario, the winch provides enough pull to break the umbilical or wireline away from the stuck latching adapter and sensor assembly, which allows normal operation of the drill rig to be restored so recovery of the drill rig possible.

In an example embodiment, the wireline umbilical 11 is a composite made up of an external armoring, that also serves as a strength member, and conductors in its core.

In operation, the latch and sensor assembly are lowered into place and latched passively into the drill bit adapter.

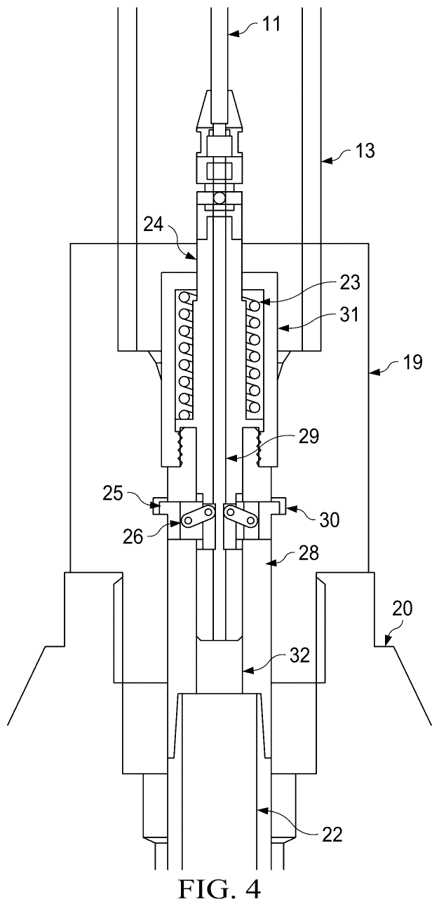

FIG. 4 shows a cross section view of the latch system. The wireline umbilical 11 is coupled to the actuator rod 24, which is loaded by spring. Latching blocks 25 are coupled to latch links 26, which connects the latch assembly to the latch adapter 19 via a latching feature 30.

The latch shown in FIG. 4 includes a spring 23 that biases the latching blocks 25 through the actuator rod 24 to the “latched” position. The latching blocks 25 move laterally, tied to the actuator rod 24 by latch links 26 which coordinate and limit their movement. The latching blocks 25 move within the latch body 28, which is connected directly to the sensor rod 22 below and the cap 31 above.

The actuator rod 24 slides up and down within the latch body cavity 32. During the latching sequence, the latching blocks 25 remain in the “unlatched” or fully retracted position while being lowered through the drill string to the operational position. Tapered lead-ins at the upper end of the drill adapter center the sensor and sensor rod 22 as they are lowered through. If the latching blocks are not fully retracted, the tapered lead-ins will compress the latching blocks 25 due to the weight of the latch assembly and sensor assembly pulling them downward. The cap 31 is a slightly larger diameter than the latch body, and it comes to rest on a shoulder at the same point that the latching blocks 25 snap into the groove in the latch adapter 19. The latch assembly is now engaged, ready for the push to begin.

During assembly, wires from the instruments are led up through the sensor rod 22 and are spliced to the umbilical wires which are led down through the wire cavity 29. The umbilical armor wires are terminated at the umbilical strength termination.

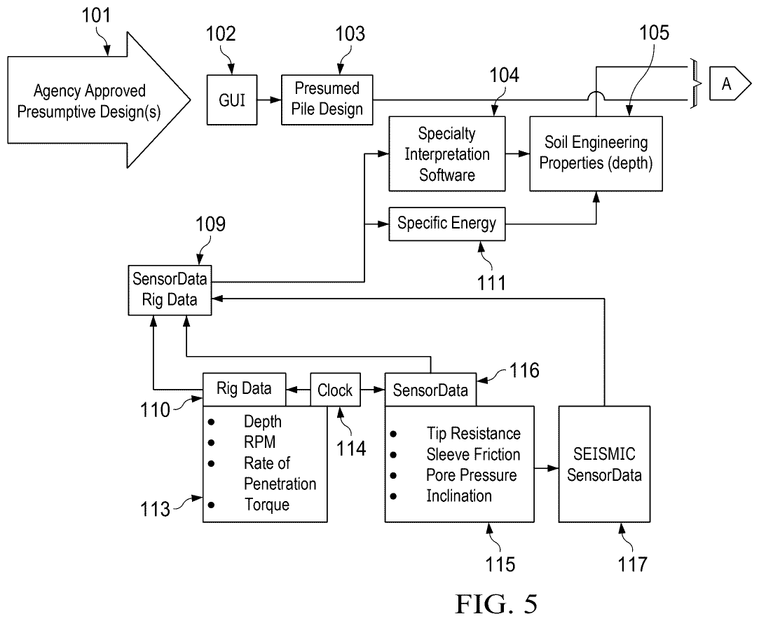

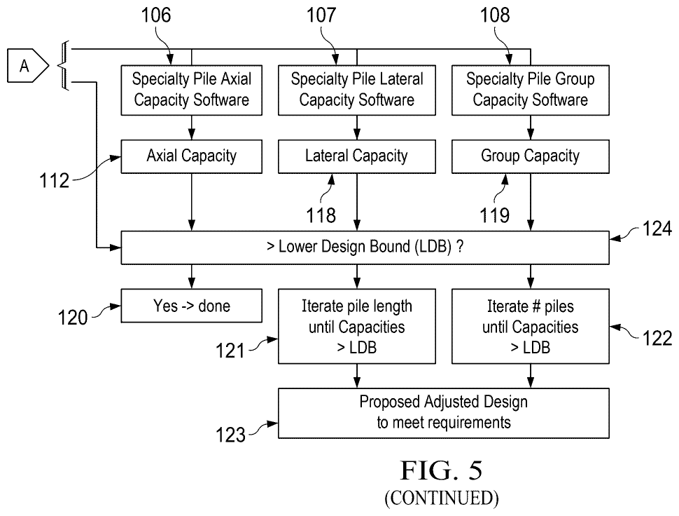

FIG. 5 is a depiction of an example embodiment of the data flow for command and control.
101 is an example of agency approved presumptive design inputs.
102 is an example of a graphical user interface.
103 is an example of a specialty interpretation software for a sensor.
105 is an example of soil engineering properties evaluation.
106 is an example of specialty pile axial capacity software.
107 is an example of specialty pile lateral capacity software.
108 is an example of specialty pile group capacity software.
109 is an example of sensor data and rig data collection.
110 is an example of rig data acquisition from multiple sensors 113 including depth, RPM, rate of penetration, and torque.
114 is an example clock that synchronizes the rig data acquisition 110 with the sensor data acquisition 116.
116 is an example embodiment of sensor data acquisition from multiple sensors 115 including tip resistance, sleeve friction, pore pressure, and inclination.
117 is an example embodiment of seismic sensor data.
111 is an example embodiment of measuring specific energy from the data acquired.
112 is an example embodiment of calculating axial capacity from the specialty pile axial capacity software 106.
118 is an example embodiment of calculating lateral capacity form the specialty pile lateral capacity software 107.
119 is an example embodiment of group capacity 119 calculated from the specialty pile group capacity software 108.
124 is an example embodiment of determining the lower design bound (LDB) 124 using the calculated axial capacity 112, the lateral capacity 118, and the group capacity 119 that results in a “yes” 120, finishing the operation, or results in iterating the pile length 121 until the capacities meet or exceed the lower design bound 124, or iterate the number of piles 122 until the capacities meet or exceed the lower design bound 124. Once the lower design bounds are met a proposed adjusted design to meet requirements 123 may be determined.

The command-and-control station will be located on the deck of the anchor installation vessel or on the ground adjacent to the micropile installation rig. It will likely be a laptop computer in a convenient shelter and will manage the operation of the ITD equipment. It will be set up to accept data from the drill rig as well as the ITD instrumentation.

The Controls Screen facilitates operation and monitoring of the system. It also allows the start-stop character of the data collection. The winch controls may include three modes: Normal operation (pay in, pay out), auto tension mode, allowing the winch to pay in or out as required to maintain a low but positive tension on the wireline wire during CPT push and withdrawal operations, and an emergency mode which forces the winch to pull hard enough to break the shear pins in the wireline termination in case of a jammed or bent CPT Assembly.

Additional control features may include a mutual lockout switch which disables drilling head rotation during winch operations and, conversely, disables winch operations during drilling processes. Data readouts give confirmation of active incoming data, indicator lights verify communications, switches allow intermittent recording of incoming data, and a switch opens the mud valve for wireline operations. On the external interfaces are the controls which allow calling third-party software tools to calculate the actual pile capacities from the measured soil conditions. The ITD system will use the results to adjust the number of piles or depth of piles to achieve the required performance. On the results screen is displayed a comparison of the presumptive and as-calculated performance of the micropile anchor. The screen also displays data collected. The example shown is pore pressure as a function of depth, highlighting the intermittent character of the data collected.

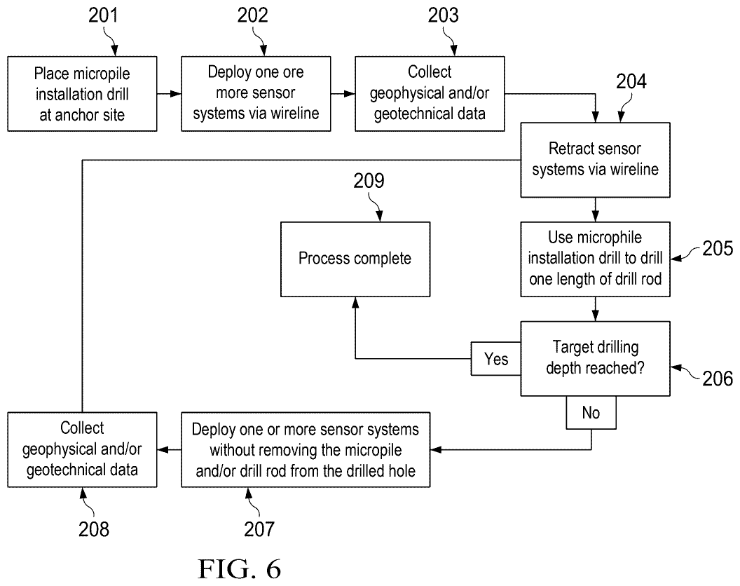

FIG. 6 is an example embodiment of the micropile process. The micropile installation drill is placed at the anchor site 201. One or more sensor systems are deployed via wireline 202. The sensors collect geophysical and/or geotechnical data 203. The sensors are retracted via wireline 204. A micropile installation drill is used to drill one length of drill rod or micropile 205. A determination is made if the target depth is reached 206. If the target depth is reached, the process is complete 209. If the target depth is not reached, then one or more sensor systems are deployed without removing the micropile and/or drill rod from the drilled hole 207. Geophysical and/or geotechnical data is collected 208. Then the sensors are retracted via wireline 204. This loop continues until the process is complete 209.

What is claimed is:

1. A method for collecting geotechnical data during the installation of a micropile comprising:
supporting one or more geotechnical and/or geophysical sensors using a micropile installation drill as a platform;
attaching a drill bit to the micropile installation drill;
installing the one or more geotechnical and/or geophysical sensors such that they do not interfere with normal operations of the micropile installation drill;
collecting data on drilling parameters from the micropile installation drill;
alternating between drilling and data collection procedures;
collecting geophysical and/or geotechnical data with a micropile in the drilled hole;
collecting geophysical and/or geotechnical data with drill rod in the drilled hole;
collecting geophysical and/or geotechnical data with a drill bit in the drilled hole;
wherein the drill bit has a hole in it passing the one or more geotechnical and/or geophysical sensors through it; and
wherein the drilling equipment does not need to be removed from the drilled hole to collect geotechnical and/or geophysical data.

2. A method for collecting geotechnical data during the installation of a micropile comprising:
supporting one or more geotechnical and/or geophysical sensors using a micropile installation drill as a platform;
collecting data on drilling parameters from the micropile installation drill;
alternating between drilling and data collection procedures;
wherein the drilling equipment does not need to be removed from the drilled hole to collect geotechnical and/or geophysical data.

3. The method of claim 2 further comprising attaching a drill bit to the micropile installation drill.

4. The method of claim 2 further wherein the drill bit has a hole in it passing the one or more geotechnical and/or geophysical sensors through it.

5. The method of claim 2 further comprising installing the one or more geotechnical and/or geophysical sensors such that they do not interfere with normal operations of the micropile installation drill.

6. The method of claim 2 further comprising collecting geophysical and/or geotechnical data with a micropile in the drilled hole.

7. The method of claim 2 further comprising collecting geophysical and/or geotechnical data with drill rod in the drilled hole.

8. The method of claim 2 further comprising collecting geophysical and/or geotechnical data with a drill bit in the drilled hole.

9. A method for calculating the anchoring capacity of a micropile during the installation of the micropile comprising:
consolidating data from one or more geotechnical geophysical sensors that collect data during the micropile installation process;
using the consolidated data from the sensors to determine the geotechnical parameters of the substrate into which the micropile is installed;
using the geotechnical parameters to calculate the anchoring capacity of the micropile.

10. The calculation method of claim 9 further comprising using geophysical and/or geotechnical data available before micropile installation begins.

11. The calculation method of claim 9 further comprising using data on drilling parameters collected from the micropile installation drill.

12. The data collection method of claim 9 further comprising calculating the anchoring capacity of a plurality of micropiles working in concert.

13. The calculation method of claim 9 further comprising calculating the micropile anchoring capacity before the micropile installation drill is removed from the installation site.

14. The calculation method of claim 9 further comprising calculating the micropile anchoring capacity after the micropile installation drill is removed from the installation site.

15. The calculation method of claim 9 further comprising using software to automatically calculate the anchoring capacity of a micropile.

16. The calculation method of claim 9 further comprising using software to automatically calculate the anchoring capacity of a plurality of micropiles working in concert.

17. A method for collecting geotechnical data during the installation of a micropile template comprising:
using a drill having a drill bit to create a hole in the ground or seabed;
using the drill to deploy sensors to collect geophysical and/or geotechnical data.

18. The data collection method of claim 17 further comprising collecting geophysical and/or geotechnical data with at least one drill rod and/or micropile in the drilled hole.

19. The data collection method of claim 17 further comprising collecting geophysical and/or geotechnical data with the drill bit already in the drilled hole.

20. The data collection method of claim 17 further comprising attaching the drill onto the micropile template after the template is placed on the ground or seabed at the intended micropile installation location.

21. The data collection method of claim 17 further comprising attaching the drill onto the micropile template before the template is placed on the ground or seabed at the intended micropile installation location.

22. The data collection method of claim 17 further comprising using the collected data to calculate the anchoring capacity of a micropile installed through the template.

23. The data collection method of claim 17 further comprising using the collected data to calculate the anchoring capacity of a plurality of micropiles working in concert and installed through the template.

24. A latching system to connect geotechnical and/or geophysical sensors to a micropile or drill rod comprising:
a wireline winch system capable of lifting and lowering equipment down the center of the drill rod and/or micropile;
a latch that connects to a geotechnical and/or geophysical sensor on one end and the wireline winch system on the other;
a latch adapter that connects to the micropile or drill rod and engages with the latch;
latch blocks that form part of the latch and extend or retract to allow the latch to lock to, or release from, the latch adapter;
latch links that connect to the latching blocks and the latch wireline termination and cause the latching blocks to retract when tension is applied to the latch wireline termination;
a spring that causes the latching blocks to extend when there is no tension on the latch wireline termination.

25. A system for latching geotechnical and/or geophysical sensors to a micropile drilling system comprising:
a latch adapter having an upper end attached to a drill rod or micropile, a lower end attached to a drill bit, and a central longitudinal latch adapter cavity entirely therethrough having an internal wall and a latching feature on the internal wall;
a latch body at least partially within the latch adapter cavity having a central longitudinal latch body cavity extending into the latch body from an upper end and at least one latch channel extending from the latch body cavity to an outer surface of the latch body;
a cap having an open end attached to the upper end of the latch body and a closed upper end distal from the latch body and having a through hole in the closed upper end, wherein the cap creates a cap cavity between its upper end and the upper end of the latch body;
an actuator rod at least partially within the cap cavity and at least partially within the latch body cavity and having an upper end extending through the through hole in the upper end of the cap attached to a cable, a lower end within the latch body cavity, a shoulder portion having an outer diameter large enough to prevent its entry into the latch adapter cavity, and a wire cavity longitudinally from its lower end to its upper end;
a spring biasing the actuator rod away from the cap and toward the latch body;
at least one latching block within the at least one latch channel connected to the actuator rod by at least one latch link;
wherein the spring bias causes the at least one link to exert an outward radial force on the latching block engaging the latching block with the latching feature on the internal wall of the drill adapter; and
wherein a force on the cable overcoming the spring bias causes the at least one link to exert an inward radial force on the latching block disengaging the latching block from the latching feature on the internal wall of the drill adapter.

26. The system for latching geotechnical and/or geophysical sensors to a micropile drilling system of claim 25 further comprising tapered lead ins at the upper end of the drill adapter adapted to compress the one or more latching blocks inward against the spring bias as the latch body is inserted into the drill adapter cavity.

27. The system for latching geotechnical and/or geophysical sensors to a micropile drilling system of claim 25 wherein the latching blocks transfer downward force from the drill rod or micropile to the latch body and at least one sensor attached to the lower end of the latch body.

28. The system for latching geotechnical and/or geophysical sensors to a micropile drilling system of claim 25 wherein the latching feature is a groove in the inner wall.

29. The system for latching geotechnical and/or geophysical sensors to a micropile drilling system of claim 25 wherein the drill adapter is integral with the drill bit.
